(19) United States
(12) Patent Application Publication
(10) Pub. No.: US 2011/0242211 A1
(43) Pub. Date: Oct. 6, 2011

(54) LIQUID EJECTION DEVICE

(75) Inventors: Ryo HAMANO, Matsumoto (JP); Daisuke HIRUMA, Matsumoto (JP); Yasushi YAJIMA, Minowamachi (JP); Norihito HARADA, Azumino (JP)

(73) Assignee: SEIKO EPSON CORPORATION, Tokyo (JP)

(21) Appl. No.: 13/078,120

(22) Filed: Apr. 1, 2011

(30) Foreign Application Priority Data
Apr. 6, 2010 (JP) 2010-088039

(51) Int. Cl. B41J 23/00

(52) U.S. Cl. 347/37

(57) ABSTRACT

A liquid ejection device includes a primary guide shaft extending along a primary scanning direction, a carriage supported on the primary guide shaft so as to be movable in the primary scanning direction, a liquid ejection head mounted on the carriage, a liquid supply tube connected at one end to a liquid storage member and connected at the other end to the liquid ejection head, and a contact member contacting a curved portion of the liquid supply tube extending from the carriage to form a curved shape. The contact member bears reactive force directed at the primary guide shaft in the conveying direction of the recording medium throughout the scanning range of the carriage from the liquid supply tube.

### CROSS-REFERENCE TO RELATED APPLICATIONS

This application claims priority to Japanese Patent Application No. 2010-088039 filed on Apr. 6, 2010. The entire disclosure of Japanese Patent Application No. 2010-088039 is hereby incorporated herein by reference.

### BACKGROUND

1. Technical Field

The present invention relates to a liquid ejection device.

2. Related Art

Inkjet printers (also referred to hereinbelow simply as “printers”) have been widely known in conventional practice as a type of liquid ejection device. Such a printer comprises a recording head (a liquid ejection head) for ejecting ink (a liquid) from nozzles formed in a nozzle formation surface, the recording head being mounted on a carriage. When the carriage moves back and forth in a primary scanning direction intersecting a conveying direction of a recording medium while being guided on a guide shaft extending in the primary scanning direction, ink is ejected from the recording head, whereby an image is formed on the recording medium.

Such printers also include the so-called off-carriage type, in which an ink cartridge (a liquid storage member) provided in the main body of the printer apart from the carriage and a recording head mounted on the carriage are connected via an ink supply tube (a liquid supply tube). The ink supply tube is fixed at one end to the main body of the printer, and is bent into a U shape at the other end and connected to the carriage. The other end of the ink supply tube moves back and forth along with the back-and-forth movement of the carriage during recording.

Therefore, in an off-carriage type of printer, the ink supply tube sometimes moves irregularly along with the back-and-forth movement of the carriage. In view of this, printers which control such ink supply tube movement have been proposed (Japanese Laid-Open Patent Publication No. 11-157288, for example).

Specifically, in the printer disclosed in Japanese Laid-Open Patent Publication No. 11-157288, a steel belt having a curved cross section is superimposed over the ink supply tube. One end of the steel belt is fixed to a stationary portion which faces the carriage movement path, and the other end is connected to the carriage.

### SUMMARY

Although the movement of the ink supply tube in the printer described above is controlled by the one end being fixed to the stationary portion, the movement of the other end near the carriage is not controlled, and the ink supply tube is therefore susceptible to being vibrated by the back-and-forth movement of the carriage. Therefore, there has been a risk of the quality of the image formed on the recording medium being reduced by the vibration of the ink supply tube being transmitted to the carriage and the recording head.

The present invention was devised in view of the problems described above, and an object thereof is to provide a liquid ejection device whereby the reduction of the recording quality on the recording medium can be suppressed.

To achieve the object described above, a liquid ejection device of a first aspect includes a primary guide shaft, a carriage, a liquid ejection head, a flexible liquid supply tube, and a contact member. The primary guide shaft extends along a primary scanning direction which intersects a conveying direction of a recording medium. The carriage is supported on the primary guide shaft so as to be movable in the primary scanning direction. The liquid ejection head is mounted on the carriage to eject a liquid onto the recording medium conveyed in the conveying direction. The flexible liquid supply tube is connected at one end to a liquid storage member disposed outside of a movement range of the carriage in order to supply the liquid to the liquid ejection head from the liquid storage member, and connected at the other end to the liquid ejection head. The contact member is fixed on the carriage and contacting a part of a curved portion of the liquid supply tube extending from the carriage to form a curved shape that opens toward one side in the primary scanning direction. The other end of the flexible liquid supply tube is connected to the liquid ejection head so that the curved portion changes in shape due to the other end of the liquid supply tube following the movement of the carriage in the primary scanning direction while being supported on the carriage. The contact member is configured to bear reactive force directed at the primary guide shaft in the conveying direction of the recording medium throughout a scanning range of the carriage from the part of the curved portion of the liquid supply tube.

According to this configuration, when the shape of the curved portion in the liquid supply tube changes along with the movement of the carriage in the primary scanning direction, the force of elastic deformation (reactive force) of the liquid supply tube created by the change in the shape of the curved portion is always acting in a direction of pressing the carriage against the primary guide shaft. Therefore, vibration of the carriage can be suppressed. Consequently, reductions in the recording quality on the recording medium can be suppressed.

In the liquid ejection device as described above, the contact member preferably has a contact surface contacting the part of the curved portion of the liquid supply tube along a plane intersecting the conveying direction of the recording medium.

According to this configuration, when the curved portion of the liquid supply tube elastically deforms along with the movement of the carriage in the primary scanning direction, the reactive force from the curved portion of the liquid supply tube can be born stably by the contact surface of the contact member, and the vibration of the carriage can be stably suppressed. Consequently, reductions in the recording quality on the recording medium can be suppressed.

In the liquid ejection device as described above, the contact surface of the contact member is preferably an inclined surface or a curved surface facing the part of the curved portion of the liquid supply tube.

According to this configuration, since the reactive force from the curved portion of the liquid supply tube can be stably born by the contact surface in the contact member configured from an inclined surface or a curved surface facing part of the curved portion of the liquid supply tube, the vibration of the carriage can be suppressed even more stably. Consequently, reductions in the recording quality on the recording medium can be suppressed.

In the liquid ejection device as described above, the carriage preferably further includes a pair of guide members which slide relative to the primary guide shaft at both ends of the carriage in the primary scanning direction. The contact member is preferably disposed between the guide members in a position adjacent to the primary guide shaft in the conveying direction of the recording medium.

According to this configuration, since direction of the reactive force of the liquid supply tube born by the contact member is between the pair of guide members, it is possible to suppress the creation of force which causes the carriage to rotate about a vertical axis on a plane parallel to the recording medium being conveyed. Consequently, reductions in the recording quality on the recording medium can be further suppressed.

The liquid ejection device as described above preferably further includes a secondary guide shaft extending parallel to the primary guide shaft and placed above the primary guide shaft as being spaced apart from the primary guide shaft. The primary guide shaft preferably supports the carriage so as to enable the carriage to turn about an axis of the primary guide shaft. The secondary guide shaft preferably contacts the carriage to allow the carriage to move in the primary scanning direction so as to control a position of the carriage in a turning direction centered around the axis of the primary guide shaft. The contact member is preferably disposed vertically between the primary guide shaft and the secondary guide shaft in a position adjacent to the primary guide shaft.

According to this configuration, the reactive force of the liquid supply tube acting on the portion of the carriage in contact with the secondary guide shaft can be reduced below the reactive force acting on the primary guide shaft. Therefore, it is possible to suppress the creation of force in a direction that causes the carriage to rotate about the axis of the primary guide shaft, and to suppress the vibration of the carriage. Consequently, reductions in the recording quality on the recording medium can be suppressed.

### BRIEF DESCRIPTION OF THE DRAWINGS

Referring now to the attached drawings which form a part of this original disclosure:

FIG. 1 is a schematic perspective view of the printer of the embodiment;

FIG. 2 is a schematic plan view of the carriage main body and the ink supply tube; and

FIGS. 3(a) through 3(c) are schematic plan views showing a state of elastic deformation in the ink supply tube in different movement positions of the carriage, wherein (a) is a schematic plan view of a case in which the carriage has moved to the left end, (b) is a schematic plan view of a case in which the carriage has moved to a middle position, and (c) is a schematic plan view of a case in which the carriage has moved to the right end.

### DETAILED DESCRIPTION OF EXEMPLARY EMBODIMENTS

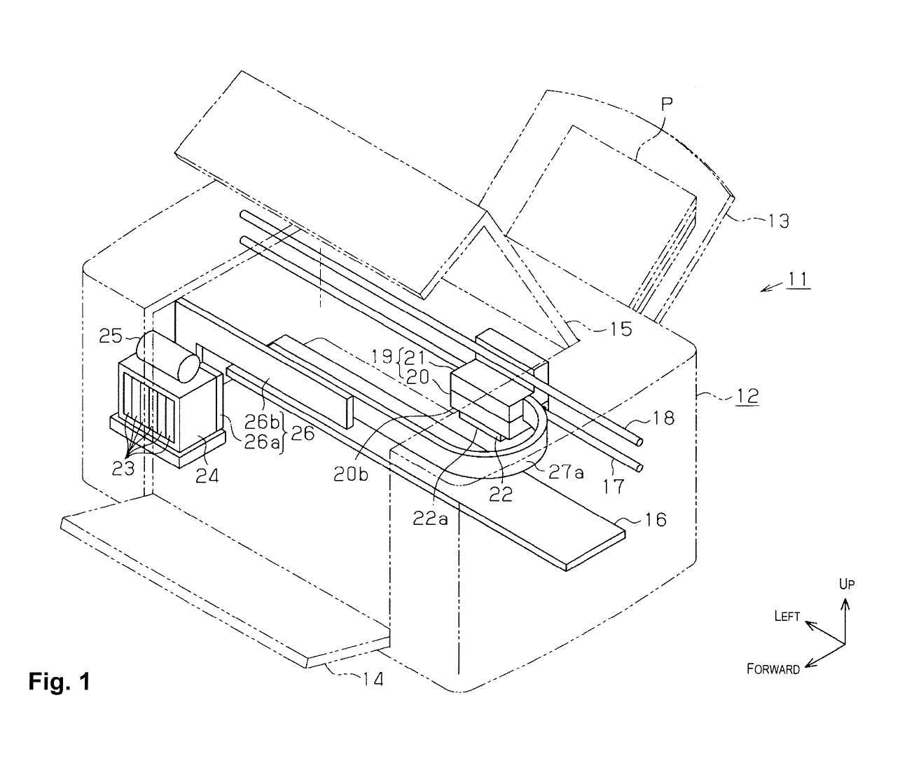

An embodiment in which the present invention is specified as an inkjet printer (hereinbelow shortened to “printer”), a type of a liquid ejection device, is described hereinbelow according to FIGS. 1 through 3. In the following description, when a “forward-backward direction,” an “up-down direction,” and a “left-right direction” are mentioned, as long as there is no particular description, they are referring respectively to the “forward-backward direction,” the “up-down direction,” and the “left-right direction” shown by the arrows in the drawings.

A printer 11 of the present embodiment comprises a substantially rectangular parallelepiped-shaped frame 12, as shown in FIG. 1. The rear surface of the frame 12 is provided with a paper supply tray 13 in which recording paper P as a recording medium can be set, and the front surface of the frame 12 is provided with a paper ejection tray 14 for guiding recording paper P which has undergone recording and been ejected from the frame 12. Furthermore, the top surface of the frame 12 is provided with a printer cover 15. The paper ejection tray 14 and the printer cover 15 can be folded and stored within the frame 12 by hinge mechanisms (not shown).

In a substantially center position in the frame 12, a rectangular platen 16 is provided in a position in the conveyed path of the recording paper P being conveyed along a conveying direction (a secondary scanning direction) running from the paper supply tray 13 to the paper ejection tray 14. The recording paper P inserted into the frame 12 from the paper supply tray 13 is supplied onto the platen 16 by a paper-feeding mechanism (not shown). The recording paper P supplied onto the platen 16 is ejected out of the frame 12 from the paper ejection tray 14.

Inside the frame 12 and above the platen 16, a circular rod-shaped primary guide shaft 17 extending in the left-right direction extends so that the left and right ends are supported on the frame 12. A carriage 19 is supported on the primary guide shaft 17 so as to be capable of moving back and forth in a direction (the primary scanning direction) intersecting the conveying direction (the secondary scanning direction) of the recording paper P and also capable of turning about the axis of the primary guide shaft 17.

Above the primary guide shaft 17, a secondary guide shaft 18, which extends in the left-right direction parallel to the primary guide shaft 17, extends so that its left and right ends are supported on the frame 12. The carriage 19 is also in contact with the secondary guide shaft 18 so as to protrude in front of the shaft. Specifically, the position of the carriage 19 in the circumferential direction (the turning direction), centered about the axis of the primary guide shaft 17, is controlled by the secondary guide shaft 18.

A carriage motor (not shown) is also installed inside the frame 12, and the carriage 19 is connected to the carriage motor via a timing belt (not shown) wound around a pair of pulleys (not shown). While the carriage 19 is guided by the primary guide shaft 17, the carriage 19 moves back and forth in the primary scanning direction while sliding on the secondary guide shaft 18, due to the driving of the carriage motor.

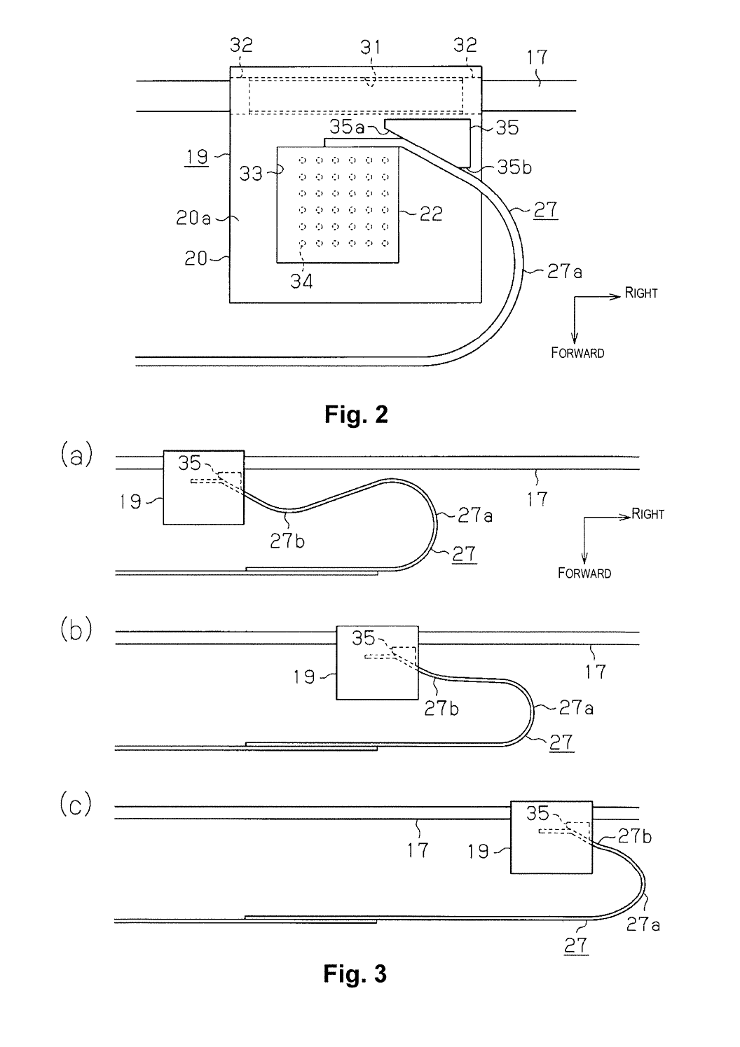

The carriage 19 is configured from a substantially rectangular carriage main body 20, and a bottomed, substantially box-shaped cover 21 for covering the top surface 20a (see FIG. 2) of the carriage main body 20. A recording head 22 as a fluid ejection head is mounted on the carriage main body 20.

Inside the frame 12, in a position to the front and to the left of the platen 16, a cartridge holder 24 is provided in which a plurality (six in the present embodiment) of ink cartridges 23 as liquid storage members that store ink are installed. A bellows pump or another pressure pump 25 is disposed on top of the cartridge holder 24. On the rear surface of the cartridge holder 24 are formed a plurality (six in the present embodiment) of ink flow channels (not shown) provided corresponding to the ink cartridges 23 within, and one end of a flat plate-shaped flow channel formation member 26 disposed so as to be parallel with the primary guide shaft 17 is also connected to the rear surface of the cartridge holder 24. The flow channel formation member 26 is configured from an attachment part 26a connected to the cartridge holder 24 and an extending part 26b extending from the top end of the attachment part 26a toward a center position inside the frame 12, so that the overall shape is a substantial L shape. A proximal end (one end) of an ink supply tube 27 as a flexible liquid supply tube is connected from a substantially center position of the extending part 26b toward a distal end at the other end.

A plurality (six in the present embodiment) of flow channels (not shown) are formed in the ink supply tube 27, and the distal end (the other end) is connected to the carriage 19. Specifically, the ink supply tube 27 is provided extending to the right from the extending part 26b of the flow channel formation member 26, and is bent partway through so that the direction of extension reverses to the left, forming a substantially U-shaped curved portion 27a which has an opening (which opens) toward one side in the primary scanning direction. The distal end of the ink supply tube 27 forming the curved portion 27a is led into the carriage 19 and connected to the recording head 22 through an opening (not shown) formed in the right side surface of the carriage 19.

Consequently, when the pressure pump 25 is driven, ink is supplied from the ink cartridges 23 to the recording head 22 via the flow channel formation member 26 and the ink supply tube 27, in accordance with the pressurized air supplied from the pressure pump 25. Specifically, the printer 11 of the present embodiment is a so-called off-carriage type of printer, wherein black, cyan, magenta, yellow, light cyan, and light magenta inks are supplied to the recording head 22.

Next, the configuration of the carriage 19 is described in detail.

A through-passage 31 which passes through the carriage main body 20 in the left-right direction is formed in the bottom of the rear of the carriage main body 20, a pair of rectangular guide members 32 having holes formed in their substantially center portions are disposed in the left and right ends of the through-passage 31, as shown in FIG. 2. The primary guide shaft 17 is designed to fit through the through-passage 31 via the guide members 32. The carriage 19 is designed to slide over the primary guide shaft 17 via the guide members 32 due to the internal peripheral surfaces of the guide members 32 sliding against the primary guide shaft 17. Consequently, the carriage 19 is capable of moving back and forth in the primary scanning direction along the primary guide shaft 17, and is also capable of turning about the primary guide shaft 17.

In the substantial center of the carriage main body 20 is formed an opening 33 which passes through the carriage main body 20 to a bottom surface 20b (see FIG. 1) and which allows the recording head 22 to be fitted therein, as shown in FIG. 2. A plurality of nozzles 34 capable of ejecting ink as a liquid are formed so as to be in systematic alignment in the bottom surface 22a (see FIG. 1) of the recording head 22, which protrudes beneath the carriage main body 20 to be exposed to the exterior via the opening 33.

The distal end (the other end) of the ink supply tube 27, which has been led into the carriage 19, is connected to the rear side of the recording head 22. An ink flow channel (not shown) for feeding ink to the nozzles 34 from the ink supply tube 27 is formed in the recording head 22. Consequently, the printer 11 performs recording on the recording paper P by discharging the ink supplied from the ink cartridges 23 out of the nozzles 34 of the recording head 22 while the carriage 19 is moved along the primary guide shaft 17 and the secondary guide shaft 18.

In the top surface 20a of the carriage main body 20, in a position between the pair of guide members 32 and to the right and rear, a contact member 35, trapezoidal in a plan view, is provided in erect fashion in order to control the direction of deformation of the ink supply tube 27 by coming in contact with the ink supply tube 27. The contact member 35 is provided so that the minimum distance from the point of contact to the primary guide shaft 17 when the contact member 35 is in contact with the ink supply tube 27 is shorter than the minimum distance to the secondary guide shaft 18. The contact member 35 comprises an inclined surface 35a which extends from the left rear to the right front as seen in a plan view, and a flat surface 35b which extends to the right from the right end of the inclined surface 35a along the primary guide shaft 17. The distal end (the other end) of the ink supply tube 27 is disposed so as to face the inclined surface 35a of the contact member 35, and the outside surface of the ink supply tube 27 comes in contact with the inclined surface 35a. Specifically, the ink supply tube 27, whose distal end (the other end) is connected to the recording head 22, comes in contact with the contact member 35 at part of the distal end, whereby the tube's direction of extension is controlled so as to become progressively farther from the primary guide shaft 17 toward the right. The tube then extends out of the carriage main body 20 from the right side surface of the carriage main body 20. The contact member 35 is designed so as to direct the direction in which the ink supply tube 27 extends out of the carriage main body 20 to the inward side of the substantially U-shaped curved portion 27a. In this regard, the inclined surface 35a functions as a contact surface which comes in contact with part of the curved portion 27a of the ink supply tube 27.

Next, the action of the printer 11 configured as described above will be described hereinbelow, with particular focus given to the action of the contact member 35 in relation to the ink supply tube 27 when the carriage 19 moves back and forth in the primary scanning direction.

When the recording process is started in the printer 11, the recording paper P is fed out from the paper supply tray 13, and the recording paper P fed out from the paper supply tray 13 is conveyed to a printing position on the platen 16. Next, the ink supplied from the ink cartridges 23 via the ink supply tube 27 is ejected from the recording head 22 while the carriage 19 moves back and forth in the primary scanning direction along the primary guide shaft 17, to perform printing on the recording paper P conveyed to the printing position on the platen 16.

When the carriage 19 has moved as far as possible to the left in the primary scanning direction as shown in FIG. 3(a), the ink supply tube 27 forms a substantially U-shaped curved portion 27a opening toward the carriage 19, and an inverted part 27b in which the curve of the curved portion 27a is inverted in the portion where the ink supply tube 27 extends out of the carriage 19. The curved portion 27a of the ink supply tube 27 has the largest possible radius and is positioned as far as possible from the carriage 19.

Since the ink supply tube 27 is flexible, when a curved portion 27a exists, force of elastic deformation (reactive force) is created which acts as though to return the curved portion 27a to a straight line. Since the ink supply tube 27 is in contact with the contact member 35 inside the carriage 19, the reactive force created in the ink supply tube 27 acts in a direction of pressing the carriage 19 against the primary guide shaft 17 via the contact member 35.

When the carriage 19 has moved to a center position in the primary scanning direction as shown in FIG. 3(b), the ink supply tube 27 extending out of the carriage 19 forms a curved portion 27a and an inverted part 27b, similar to the case in which the carriage 19 had moved as far as possible to the left. The radius of the curved portion 27a is smaller than in the case in which the carriage 19 had moved as far as possible to the left, and the position of the curved portion 27a is nearer to the carriage 19. As in the case in which the carriage 19 has moved as far as possible to the left, the reactive force of the ink supply tube 27 acts on the carriage 19 via the contact member 35.

When the carriage 19 has moved as far as possible to the right in the primary scanning direction as shown in FIG. 3(c), the ink supply tube 27 extends out of the carriage 19 so as to head toward the inward surface of the curved portion 27a, and the curved portion 27a and inverted part 27b are formed as in the cases described above. The curved portion 27a has the smallest possible radius, and the position of the curved portion 27a reaches the nearest point to the carriage 19. The reactive force of the ink supply tube 27 acts on the carriage 19 via the contact member 35 similar to the cases in which the carriage 19 had moved to the farthest left and to the center position.

Thus, when the carriage 19 moves back and forth in the primary scanning direction, the curved portion 27a and the inverted part 27b are always formed in the ink supply tube 27 throughout the entire scanning range of the carriage 19. The reactive force of the ink supply tube 27 is always acting in a direction of pressing the carriage 19 against the primary guide shaft 17. Therefore, the vibration of the carriage 19 during scanning is suppressed.

Since the contact member 35 is formed in a region between the pair of guide members 32 provided to the carriage 19 and in a position near the primary guide shaft 17 in the forward-backward direction, which is the conveying direction of the recording paper P, the reactive force of the ink supply tube 27 born by the contact member 35 acts inside the range between the pair of guide members 32. Therefore, when the reactive force of the ink supply tube 27 takes effect, it suppresses the creation of force that causes the carriage 19 to rotate about a vertical axis in a plane parallel to the recording medium being conveyed, and also suppresses the change in the rotational direction of the carriage 19.

Furthermore, since the contact member 35 is disposed so that the distance from the point of contact with the ink supply tube 27 in the inclined surface 35a to the primary guide shaft 17 is smaller than the distance to the secondary guide shaft 18, the reactive force of the ink supply tube 27 acting on the portion of the carriage 19 in contact with the secondary guide shaft 18 is less than the reactive force acting on the primary guide shaft 17. Therefore, when the reactive force of the ink supply tube 27 takes effect, it suppresses the creation of force directed in a direction causing the carriage 19 to rotate about the axis of the primary guide shaft 17, and also suppresses the change in the rotational direction of the carriage 19.

According to the embodiment described above, the following effects can be achieved.

(1) When the shape of the curved portion 27a in the ink supply tube 27 changes along with the movement of the carriage 19 in the primary scanning direction, the force of elastic deformation (reactive force) of the ink supply tube 27 created by the change in the shape of the curved portion 27a is always acting in a direction of pressing the carriage 19 against the primary guide shaft 17. Therefore, vibration of the carriage 19 can be suppressed. Consequently, reductions in the recording quality on the recording paper P can be suppressed.

(2) When the curved portion 27a of the ink supply tube 27 elastically deforms along with the movement of the carriage 19 in the primary scanning direction, the reactive force from the curved portion 27a of the ink supply tube 27 can be born stably by the inclined surface 35a of the contact member 35. Therefore, the vibration of the carriage 19 can be stably suppressed. Consequently, reductions in the recording quality on the recording paper P can be suppressed.

(3) The direction of the reactive force in the ink supply tube 27 born by the contact member 35 is between the pair of guide members 32. Therefore, it is possible to suppress the creation of force which causes the carriage 19 to rotate about the axis of the primary guide shaft 17, and also to suppress the change in the rotational direction of the carriage 19. Consequently, reductions in the recording quality on the recording paper P can be further suppressed.

(4) Since the contact member 35 is positioned between the primary guide shaft 17 and secondary guide shaft 18 in the up-down direction and near the primary guide shaft 17, the reactive force of the ink supply tube 27 in relation to the portion of the carriage 19 in contact with the secondary guide shaft 18 is less than the reactive force relative to the primary guide shaft 17. Therefore, it is possible to suppress the creation of force in a direction that causes the carriage 19 to rotate about the axis of the primary guide shaft 17, to suppress the change in the rotational direction of the carriage 19, and to suppress the vibration of the carriage 19. Consequently, reductions in the recording quality on the recording paper P can be suppressed.

The embodiment described above may be modified as follows.

The number of ink colors, the number of flow channels formed in the ink supply tube 27, the number of ink cartridges 23, and the number of nozzle openings 34 formed in the recording head 22 can be set as desired.

The contact member 35 is not limited to a trapezoidal shape in a plan view, and may be formed into a columnar shape or a plate shape, for example.

The secondary guide shaft 18 does not necessarily need to be included. The contact member 35 also does not need to have the contact point with the ink supply tube 27 positioned near the primary guide shaft 17. In this case, the carriage 19 is preferably designed so that it does not rotate about the axis of the primary guide shaft 17 on account of its own weight.

If the carriage 19 is capable of sliding along the primary guide shaft 17, the guide members 32 do not need to be provided at the ends of the through-passage 31. The contact member 35 may also be disposed in a region not between the pair of guide members 32. Furthermore, the contact member 35 may be disposed in a position away from the primary guide shaft 17 in the secondary scanning direction.

The surface of the contact member 35 that is in contact with the ink supply tube 27 is not limited to the inclined surface 35a, and may be a curved surface, for example. It may also be another surface (e.g., a flat surface) besides an inclined surface or a curved surface as long as it runs along a direction that intersects the conveying direction of the recording paper P. Furthermore, the portion in contact with the ink supply tube 27 may be formed so as to be in point contact, for example, instead of surface contact.

In the embodiment described above, the liquid ejection device is specified as an inkjet printer 11, but a liquid ejection device which ejects or discharges another liquid other than ink may also be used. The liquid ejection device can be applied in various liquid ejection devices which comprise a liquid ejection head or the like for discharging extremely small droplets. The term “droplets” refers to the state of the liquid discharged from the liquid ejection device, and includes that which leaves trails of grains, tears, or threads. The liquid referred to herein need only be a substance that can be ejected by the liquid ejection device. For example, the material need only be in the state of a liquid which includes not only fluids such as liquids of high and low viscosity, sols, gels, other inorganic solvents, organic solvents, solutions, liquid resins, and liquid metals (metal melts); and liquids as one state of the substance; but also includes liquids containing particles of functional materials composed of pigments, metal particles, or the like which are dissolved, dispersed, or mixed in a solvent. Typical examples of the liquids include ink such as the ink described in the embodiment described above, liquid crystal, and the like. The term “ink” used herein includes common water-based ink and oil-based ink, as well as gel ink, hot melt ink, and other various liquid compositions. Specific examples of the liquid ejection device include liquid ejection devices which eject a liquid containing an electrode material, a coloring material, or the like in the form of a dispersion or a solvent, which is used in the manufacture of liquid crystal displays, EL (electroluminescence) displays, surface-emitting displays, color filters, and the like, for example; liquid ejection devices which eject a biological organic substance used to manufacture biochips; liquid ejection devices which are used as precision pipettes and which eject a liquid as a test sample; printing devices, micro dispensers; and the like. Further options which may be used include liquid ejection devices which eject lubricating oil at pinpoints onto watches, cameras, and other precision instruments; liquid ejection devices for ejecting an ultraviolet curing resin or another transparent resin liquid onto a substrate in order to form a microscopic semispherical lens (optical lens) or the like used in an optical communication element or the like; and liquid ejection devices for ejecting an acid, an alkali, or another etching liquid in order to etch a substrate or the like. The present invention can be applied to any one of these types of liquid ejection devices.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A liquid ejection device comprising:
a primary guide shaft extending along a primary scanning direction which intersects a conveying direction of a recording medium;
a carriage supported on the primary guide shaft so as to be movable in the primary scanning direction;
a liquid ejection head mounted on the carriage to eject a liquid onto the recording medium conveyed in the conveying direction;
a flexible liquid supply tube connected at one end to a liquid storage member disposed outside of a movement range of the carriage in order to supply the liquid to the liquid ejection head from the liquid storage member, and connected at the other end to the liquid ejection head; and
a contact member fixed on the carriage and contacting a part of a curved portion of the liquid supply tube extending from the carriage to form a curved shape that opens toward one side in the primary scanning direction,
the other end of the flexible liquid supply tube being connected to the liquid ejection head so that the curved portion changes in shape due to the other end of the liquid supply tube following the movement of the carriage in the primary scanning direction while being supported on the carriage, and
the contact member being configured to bear reactive force directed at the primary guide shaft in the conveying direction of the recording medium throughout a scanning range of the carriage from the part of the curved portion of the liquid supply tube.

2. The liquid ejection device according to claim 1, wherein
the contact member has a contact surface contacting the part of the curved portion of the liquid supply tube along a plane intersecting the conveying direction of the recording medium.

3. The liquid ejection device according to claim 2, wherein
the contact surface of the contact member is an inclined surface or a curved surface facing the part of the curved portion of the liquid supply tube.

4. The liquid ejection device according to claim 1, wherein
the carriage further includes a pair of guide members which slide relative to the primary guide shaft at both ends of the carriage in the primary scanning direction, and
the contact member is disposed between the guide members in a position adjacent to the primary guide shaft in the conveying direction of the recording medium.

5. The liquid ejection device according to claim 1, further comprising
a secondary guide shaft extending parallel to the primary guide shaft and placed above the primary guide shaft as being spaced apart from the primary guide shaft,
the primary guide shaft supporting the carriage so as to enable the carriage to turn about an axis of the primary guide shaft,
the secondary guide shaft contacting the carriage to allow the carriage to move in the primary scanning direction so as to control a position of the carriage in a turning direction centered around the axis of the primary guide shaft, and
the contact member being disposed vertically between the primary guide shaft and the secondary guide shaft in a position adjacent to the primary guide shaft.
